(19) United States
(12) Patent Application Publication
(10) Pub. No.: US 2025/0106383 A1
(43) Pub. Date: Mar. 27, 2025

(54) COMPETITION BASED DISPLACEMENT SKIP FOR MESH COMPRESSION

(71) Applicant: TENCENT AMERICA LLC, Palo Alto, CA (US)

(72) Inventors: Xiaozhong XU, State College, PA (US); Shan LIU, San Jose, CA (US)

(73) Assignee: TENCENT AMERICA LLC, Palo Alto, CA (US)

(21) Appl. No.: 18/891,201

(22) Filed: Sep. 20, 2024

Related U.S. Application Data
(60) Provisional application No. 63/539,780, filed on Sep. 21, 2023.
(60) Provisional application No. 63/539,779, filed on Sep. 21, 2023.

(51) Int. Cl. H04N 19/105; H04N 19/147; H04N 19/184; H04N 19/54

(52) U.S. Cl. CPC H04N 19/105; H04N 19/147; H04N 19/184; H04N 19/54

(57) ABSTRACT

A method includes receiving a polygon mesh that includes a plurality of vertices; generating a set of candidate predictors, each candidate predictor in the set of candidate predictors corresponding to a respective displacement vector between a vertex from the plurality of vertices to a vertex to be coded; selecting a candidate predictor from the set of candidate predictors; and generating a bitstream that includes at least a candidate predictor index corresponding to the selected candidate predictor.

### CROSS-REFERENCE TO RELATED APPLICATION

This application claims priority from U.S. Provisional Application No. 63/539,780 filed on Sep. 21, 2023 and U.S. Provisional Application No. 63/539,779 filed on Sep. 21, 2023, the disclosures of each of which are incorporated herein by reference in their entirety.

### FIELD

This disclosure is directed to a set of advanced video coding technologies. More specifically, the present disclosure is directed to a method and apparatus for competition based displacement skip for mesh compression.

### BACKGROUND

The advances in 3D capture, modeling, and rendering have promoted the ubiquitous presence of 3D contents across several platforms and devices. Nowadays, it is possible to capture a baby's first step in one continent and allow the grandparents to see (and maybe interact) and enjoy a full immersive experience with the child in another continent. Nevertheless, in order to achieve such realism, models are becoming ever more sophisticated, and a significant amount of data is linked to the creation and consumption of those models. 3D meshes are widely used to represent such immersive contents.

A mesh is composed of several polygons that describe the surface of a volumetric object. Each polygon is defined by its vertices in 3D space and the information of how the vertices are connected, referred to as connectivity information. Optionally, vertex attributes, such as colors, normals, etc., could be associated with the mesh vertices. Attributes could also be associated with the surface of the mesh by exploiting mapping information that parameterizes the mesh with 2D attribute maps. Such mapping is usually described by a set of parametric coordinates, referred to as UV coordinates or texture coordinates, associated with the mesh vertices. 2D attribute maps are used to store high resolution attribute information such as texture, normals, displacements etc. Such information could be used for various purposes such as texture mapping and shading.

A dynamic mesh sequence may require a large amount of data since it may consist of a significant amount of information changing over time. Therefore, efficient compression technologies are required to store and transmit such contents. Mesh compression standards IC, MESHGRID, FAMC were previously developed by MPEG to address dynamic meshes with constant connectivity and time varying geometry and vertex attributes. However, these standards do not take into account time varying attribute maps and connectivity information. DCC (Digital Content Creation) tools usually generate such dynamic meshes. In counterpart, it is challenging for volumetric acquisition techniques to generate a constant connectivity dynamic mesh, especially under real time constraints. This type of contents is not supported by the existing standards. MPEG is planning to develop a new mesh compression standard to directly handle dynamic meshes with time varying connectivity information and optionally time varying attribute maps. This standard targets lossy, and lossless compression for various applications, such as real-time communications, storage, free viewpoint video, AR and VR. Functionalities such as random access and scalable/progressive coding are also considered.

### SUMMARY

According to an aspect of the disclosure, a method of encoding performed by at least one processor includes receiving a polygon mesh that includes a plurality of vertices; generating a set of candidate predictors, each candidate predictor in the set of candidate predictors corresponding to a respective displacement vector between a vertex from the plurality of vertices to a vertex to be coded; selecting a candidate predictor from the set of candidate predictors; and generating a bitstream that includes at least a candidate predictor index corresponding to the selected candidate predictor.

According to an aspect of the disclosure, a method of decoding performed by at least one processor, includes receiving a bitstream that includes an encoded polygon mesh; generating a candidate predictor set associated with the encoded polygon mesh; selecting a candidate predictor from the candidate predictor set; generating a set of candidate predictors, each candidate predictor in the set of candidate predictors corresponding to a respective displacement vector between a vertex from the plurality of vertices to a vertex to be coded; selecting a candidate predictor from the set of candidate predictors; and decoding one or more vertices of the encoded polygon mesh using the selected candidate predictor.

According to an aspect of the disclosure, a method of encoding performed by at least one processor includes generating a bitstream for a polygon mesh that includes a plurality of vertices, in which a set of candidate predictors are generated, each candidate predictor in the set of candidate predictors corresponding to a respective displacement vector between a vertex from the plurality of vertices to a vertex to be coded, in which a candidate predictor from the set of candidate predictors is selected, in which a candidate predictor index corresponding to the selected candidate predictor is included in the bitstream.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of a block diagram of a communication system, in accordance with embodiments of the present disclosure.

FIG. 2 is a schematic illustration of a block diagram of a streaming system, in accordance with embodiments of the present disclosure.

FIG. 3 illustrates vertex prediction using edge-based interpolation, in accordance with embodiments of the present disclosure.

FIG. 4 illustrates example candidate predictors and associated displacements, in accordance with embodiments of the present disclosure.

FIG. 5 illustrates an flowchart of an example encoding process, in accordance with embodiments of the present disclosure.

FIG. 6 illustrates an flowchart of an example decoding process, in accordance with embodiments of the present disclosure.

FIG. 7 illustrates an example computer system diagram, in accordance with embodiments of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

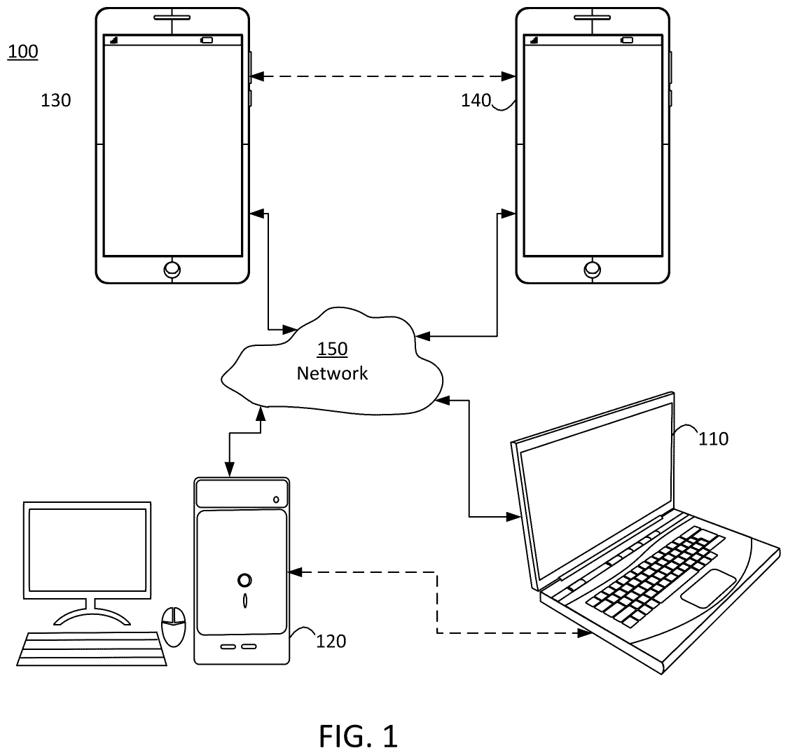

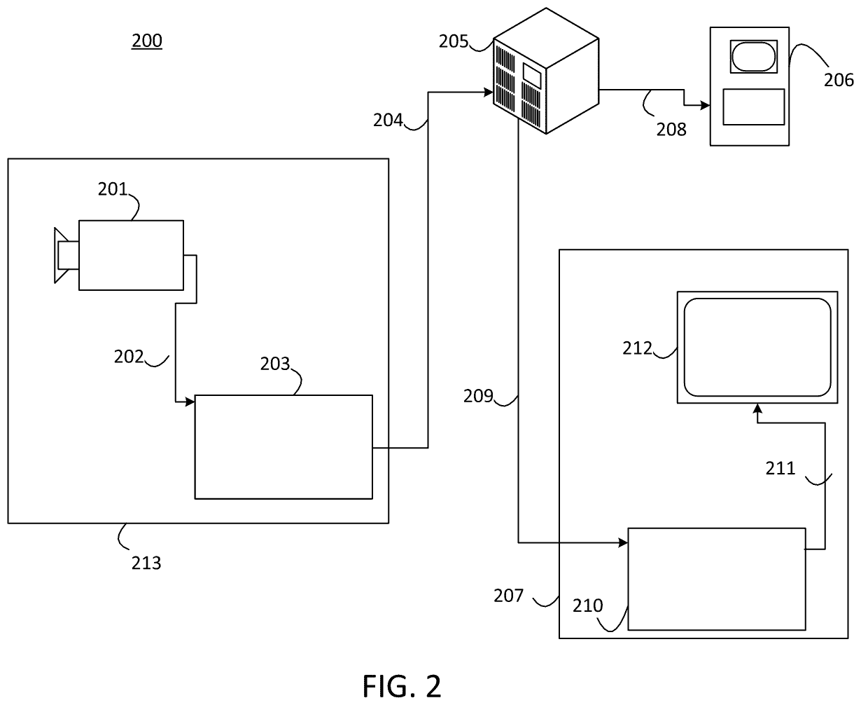

With reference to FIGS. 1-2, one or more embodiments of the present disclosure for implementing encoding and decoding structures of the present disclosure are described.

FIG. 1 illustrates a simplified block diagram of a communication system 100 according to an embodiment of the present disclosure. The system 100 may include at least two terminals 110, 120 interconnected via a network 150. For unidirectional transmission of data, a first terminal 110 may code video data, which may include mesh data, at a local location for transmission to the other terminal 120 via the network 150. The second terminal 120 may receive the coded video data of the other terminal from the network 150, decode the coded data and display the recovered video data. Unidirectional data transmission may be common in media serving applications and the like.

FIG. 1 illustrates a second pair of terminals 130, 140 provided to support bidirectional transmission of coded video that may occur, for example, during videoconferencing. For bidirectional transmission of data, each terminal 130, 140 may code video data captured at a local location for transmission to the other terminal via the network 150. Each terminal 130, 140 also may receive the coded video data transmitted by the other terminal, may decode the coded data and may display the recovered video data at a local display device.

In FIG. 1, the terminals 110-140 may be, for example, servers, personal computers, and smart phones, and/or any other type of terminals. For example, the terminals (110-140) may be laptop computers, tablet computers, media players and/or dedicated video conferencing equipment. The network 150 represents any number of networks that convey coded video data among the terminals 110-140 including, for example, wireline and/or wireless communication networks. The communication network 150 may exchange data in circuit-switched and/or packet-switched channels. Representative networks include telecommunications networks, local area networks, wide area networks, and/or the Internet. For the purposes of the present discussion, the architecture and topology of the network 150 may be immaterial to the operation of the present disclosure unless explained herein below.

FIG. 2 illustrates, as an example of an application for the disclosed subject matter, a placement of a video encoder and decoder in a streaming environment. The disclosed subject matter may be used with other video enabled applications, including, for example, video conferencing, digital TV, storing of compressed video on digital media including CD, DVD, memory stick and the like, and so on.

As illustrated in FIG. 2, a streaming system 200 may include a capture subsystem 213 that includes a video source 201 and an encoder 203. The streaming system 200 may further include at least one streaming server 205 and/or at least one streaming client 206.

The video source 201 may create, for example, a stream 202 that includes a 3D mesh and metadata associated with the 3D mesh. The video source 201 may include, for example, 3D sensors (e.g. depth sensors) or 3D imaging technology (e.g. digital camera(s)), and a computing device that is configured to generate the 3D mesh using the data received from the 3D sensors or the 3D imaging technology. The sample stream 202, which may have a high data volume when compared to encoded video bitstreams, may be processed by the encoder 203 coupled to the video source 201. The encoder 203 may include hardware, software, or a combination thereof to enable or implement aspects of the disclosed subject matter as described in more detail below. The encoder 203 may also generate an encoded video bitstream 204. The encoded video bitstream 204, which may have a lower data volume when compared to the uncompressed stream 202, may be stored on a streaming server 205 for future use. One or more streaming clients 206 and 207 may access the streaming server 205 to retrieve video bit streams 208 and 209, respectively that may be copies of the encoded video bitstream 204.

The streaming clients 207 may include a video decoder 210 and a display 212. The video decoder 210 may, for example, decode video bitstream 209, which is an incoming copy of the encoded video bitstream 204, and create an outgoing video sample stream 211 that may be rendered on the display 212 or another rendering device (not depicted). In some streaming systems, the video bitstreams 204, 208, and 209 may be encoded according to certain video coding/compression standards.

In one or more examples, to represent a mesh signal efficiently, a subset of the mesh vertices may be coded first, together with the connectivity information among them. In the original mesh, the connection among these vertices may not exist as they are subsampled from the original mesh. There are different ways to generate the connectivity information among the vertices. This subset is therefore referred to as the base mesh or base vertices.

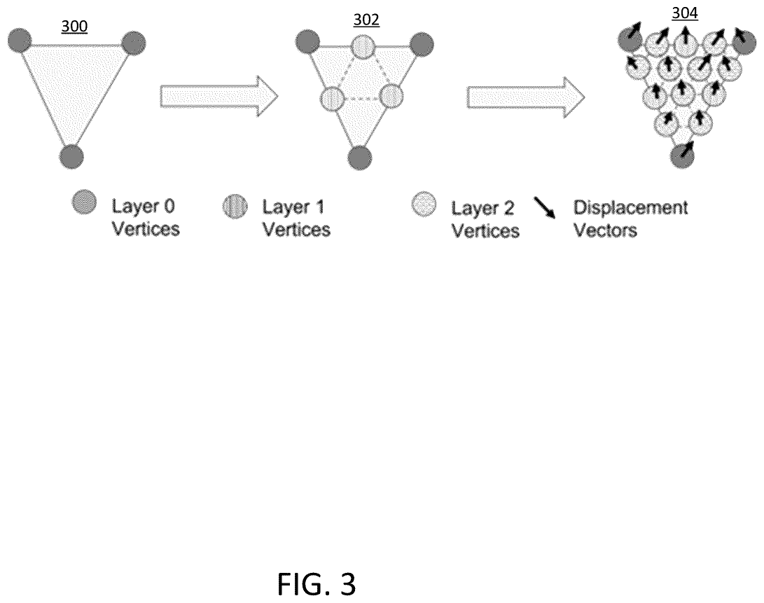

Other vertices, however, can be predicted by applying interpolation between two or more already decoded mesh vertices. A predictor vertex will have its geometry location along the edge of two connected existing vertices, so the geometry information of the predictor can be calculated based on the neighboring decoded vertices. In some cases, the displacement vector or the prediction error, from the to-be-coded vertex to the vertex predictor, is to be further coded after decoding the base vertices (e.g. the solid triangle 300 in FIG. 3). These vertices may be referred to as layer 0, where interpolation among these base vertices can be done along the connected edges. For example, the middle point of each edge can be generated as predictors. The geometry locations of these interpolated points are therefore (weighted) average of the two neighboring decoded vertices (the dashed points in FIG. 3 referring to mesh 302). Having more than 1 middle point between two already decoded vertices can also be done in a similar way. The actual vertices to be coded can therefore be reconstructed by adding the displacement vectors to the predictors (FIG. 3 Layer 1 vertices). After decoding these additional vertices, the connection among the newly decoded vertices and the existing base vertices may still maintained. In addition, connection among the newly decoded vertices can be further established. Together with the base vertices, more intermediate vertices predictors can be generated along the new edges (FIG. 3 referring to mesh 304, Layer 2 vertices) by connecting these newly decoded vertices and base vertices together. Therefore, there may be more actual vertices to be decoded with associated displacement vectors. Such an interpolation-based vertex prediction can be continued, until the total number of layers has been reached.

The displacement vectors of all layers (including those for the layer 0, or the base vertices), may be processed using various methods, such as grouping them together to perform transformation and entropy coding.

Displacements are not restricted to sub-division of a base mesh. Displacements may be produced by other mesh encoding tools, such as symmetry coding, etc. In all cases, they need to be predicted, for the improved compression. A typical approach for displacement coding is the so-called “lifting” scheme. In such as scheme, first, the reconstructed quantized base mesh is used to update the displacement field to generate an updated displacement field. This process considers the differences between the reconstructed base mesh and the original base mesh. Then a wavelet transform is applied, and a set of wavelet coefficients is generated. The wavelet coefficients are then quantized and packed into a 2D image/video or directly encoded with an arithmetic encoder.

Mesh compression can be a lossy process: the size of the bitstream, information to transmit, is reduced, at the cost of a distortion introduced in the decoded mesh. The compromise between bitrate saving and induced distortion is a typical problem in mesh compression. While the creation of displacements by coding tools allows better reconstructions of meshes at the decoder, the cost of displacement information is significant in a typical bitstream. Reducing this cost while preserving the quality is the major problem addressed in this invention disclosure.

Embodiments of the present disclosure directed to methods and systems are proposed for prediction of displacements in 3D compression, such as mesh compression. The embodiments can be applied individually or by any form of combination. The disclosed methods and systems are not limited to mesh compression.

The following operations may be performed for encoding.

A set of candidate predictors for displacements (see set of candidate predictors) containing one or more candidate predictors (see candidate predictors) may be created. For each displacement to predict: (A) For each candidate predictor in the set, (i) computation of the candidate predictor: the candidate predictor is computed from neighbor information (see candidate predictors) (ii) Computation of the displacement residual (see residual computation), and (iii) Evaluation of the displacement cost associated to the candidate predictor (see selection criterion); (B) Selection of the best candidate predictor (see selection criterion); (C) Signaling of the displacement residual and signaling of the selected candidate predictor index in the bitstream (see signaling); alternatively, without signaling, infer the selected predictor candidate.

The following operation may be performed for decoding.

For each displacement: (A) Parsing of the bitstream to retrieve the displacement residual and to retrieve the selected candidate predictor index from the generated candidate predictor set; alternatively, without signaling of the index, infer the selected predictor candidate from the generated candidate predictor set; (B) Computation of the selected candidate predictor (see candidate predictors); (C) Computation of the reconstructed displacement (see inverse residual computation) or assign the selected candidate predictor to the displacement.

The embodiments of the present disclosure provide a number of advantages. First, predicting the displacement and sending a residual and an index reduces the signaling cost for displacement. This allows to use less bits for the mesh with an equivalent visual quality, or to allocate more bits to other information to increase the visual quality. Furthermore, Using less bits to encode displacements allows for better subdivision (more vertices), thereby resulting in finer fidelity to the original, with equivalent displacement cost. Furthermore, skipping the transmission of the displacement and predicting the displacement due to transmission of the index reduces the signaling cost for displacement. Compared to a competition based displacement prediction, the embodiments of the present disclosure will have a lower bitrate, at the price of a higher transmission.

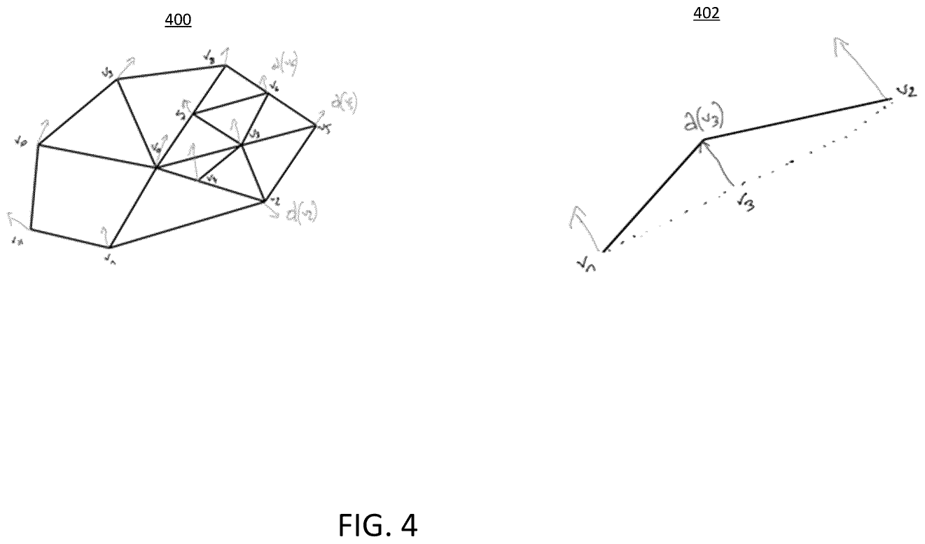

According to one or more embodiments, candidate predictors may be defined to predict the displacement. FIG. 4 illustrates a non exhaustive list of candidate predictors.

In FIG. 4, vi (i is the index to represent different positions) may represent the vertices in a local neighborhood, and d (vi) the associated displacements. In one or more examples, the preferred embodiment, a candidate predictor can be computed as:

$$cand\_pred = 1 / SUM ( wi ) * SUM ( wi * d ( vi ) ) , i = 1 to n , \qquad Eq . ( 1 )$$

where wi are weights associated with some local characteristics, like the distance between the vertex and the displacement, etc; SUM (*) is the summation of a set of variables in the parentheses. The wi can be recovered at the decoder (do not need to be transmitted).

The faces in the mesh 400 or mesh 402 of FIG. 4 are either faces of a base mesh, or sub-faces obtained after sub-division of a base mesh.

Eq. (1) includes the following cases:
0 displacement is considered as the candidate predictor (with all wi equal to 0).
Just one displacement is considered as the candidate predictor (all wi equal to 0 except one). This allows one to consider one neighbor vertex only.
The displacement is the average of the displacements of the two edge vertices (all wi equal to 0 except the two wi associated to the edge vertices equal to ½).
In particular, if a vertex is generated by interpolating from two neighboring vertices sharing the same edge, then its displacement can be predicted by a weighted average of these two “parent” vertices.

According to one or more embodiments, the candidate predictors may be obtained by a machine learning based algorithm where a training is performed to learn the most appropriate candidate predictor, given features made of local information, or general mesh information. In one or more examples, the candidate predictors may be a curve fitting algorithm (considering the curvature, based on several vertices positions), equations of the surface can be computed, and predictors can be derived.

In one or more examples, the displacements d (vi) are decoded displacements available at both the encoder and the decoder, to avoid any drift resulting from the quantization, during the reconstruction of the displacement by the decoder. In one or more examples, the displacements d (vi) are original displacements, to increase prediction accuracy, at the cost of a drift resulting from the quantization of the displacements.

In one or more examples, a set of candidate predictors contains one or more candidate predictors, among which one optimal predictor is later selected. The candidate predictors forming the set can vary as follows: (i) Depending on the local mesh characteristics (curvature, etc), some candidate predictors are more relevant than others; (ii) Depending on faces geometry (size, distance between vertices), some candidate predictors are more relevant than others; or (iii) Depending on the result of a multi-pass approach, where a first coding is applied and statistics are derived, to extract characteristics of relevant candidate predictors.

When the set varies, the candidates and the order in the set selected can be based on automatically selected based on information available at the decoder or signaled in the bitstream (an index identifies each set). The number of candidate predictors in the set can vary. Depending on the complexity of the prediction, having a smaller set candidate predictor or larger set is more relevant.

The variation of the candidate predictor set is possible at the mesh level, sub-mesh level, or for any different defined partitioning of the mesh. As an example, the part of a mesh representing the face of a human body needs more predictors in the set than the part of the mesh representing the flat back of a human body. As another example, in case of recursive split of the mesh, or level of details context, a different set can be used at each level. The number of candidates in the set can be signaled at a mesh frame header and will be applied to all the vertices in the mesh frame. Or as an alternative, it can be signaled and applied at each sub-mesh level.

Having a varying set of predictors provides a number of advantages. For example, different part of the meshes have different characteristics, that can take advantage of different set of candidate predictors. As a result, the cost of the displacements is optimized locally. Furthermore, while a large set of predictors will increase the efficiency of the prediction, it will decrease the efficiency of the signaling (selecting the optimal candidate predictor index, in a large set, is expensive). Having a varying set of predictors is a way to address this compromise between prediction and signalling efficiency.

In one or more examples, the residual computation includes computing a difference (residual_displacement) between the displacement to be predicted (displacement) and the selected candidate predictor sel_cand_pred:

$$residual\_displacement = displacement - sel\_cand \_pred \qquad Eq . ( 2 )$$

The difference, represented by the sign “−”, may be an operator that computes the difference between two objects. In one or more examples, the “−” operator may be the Euclidean distance computed separately on each of the 3 components of the displacement. The difference may be a reversible operator.

In one or more examples, the inverse residual computation, performed at the decoder, may include computing the reconstructed displacement from the transmitted residual displacement, and the selected candidate predictor, retrieved through transmitted predictor index.

In one or more examples, the residual computation is performed for each candidate predictor. The candidate predictor that minimizes a cost criterion is selected as the optimal candidate predictor (sel_cand_pred). It provides the best compromise between the cost of signaling information in the bitstream, and the quality degradation. In one or more examples, the cost may be expressed as:

$$J = D + lambda * R . \qquad Eq . ( 3 )$$

In Eq. (3), lambda is a Lagrangian parameter. D is the distortion, measuring a difference between the source displacement and the reconstructed displacement after prediction with the candidate predictor. The distortion may be approximated with an objective metric, such as D2 or the luma PSNR, for instance. R is the rate associated to all information that require signaling, or an approximation of this rate. R includes the rate of the residual displacement, and the rate of the optimal candidate predictor index.

In one or more examples, the residual of the displacement (residual_displacement) is sent in the bitstream. Classical entropic/arithmetic coding algorithms may be used. In one or more examples, the index corresponding to the selected candidate predictor is sent in the bitstream. An index is associated to each candidate predictor. In a typical encoding, the number of bits used by this index will be low for the most frequently selected candidate predictors. In one or more examples, the index of the predictor is not sent in the bitstream. The index may be inferred via information available at both encoder and decoder.

In one or more examples, multi-face prediction may be used. In multi-face prediction, the same selected candidate predictor may be used for a group of faces. The result is a lower prediction efficiency, yet less indices need to be transmitted. The group of faces may be consecutives faces in a given encoding order, or faces gathered according to some predefined criterion, applicable at the decoder. In one or more examples, the selection criterion may be modified so that the distortion is average over all faces of the group and weighted according to some criterion available of the decoder. For instance, larger faces can have a larger weight because they contribute more to the overall distortion. In this multi-face approach, the rate may be the sum of the rates of each face of the group.

In one or more examples, a recursive/layered-based approach may be used. In this approach, the competition is applicable in a layered approach as depicted in FIG. 3. Candidate displacements are provided by the face currently being encoded. Candidate predictors are computed from displacements obtained from a given level of the hierarchy and used for the next level. While this approach allows some scalability (the decomposition in levels can be stopped according to a given criterion), there is delay in the prediction process, and less predictors are available.

In one or more examples, a non-recursive approach may be used. In this approach, the competition is applicable in a non recursive approach. Candidate predictors are computed from displacements obtained from neighbor faces, already decoded. In this situation, not only the displacements from the vertices of the face are available, but also the displacement of all sub-faces resulting for sub-division. All these displacements, and functions of them, may be used to compute the candidate predictors.

In one or more examples, instead of selecting and signaling one candidate predictor per face, and, instead of selecting one candidate predictor for a group of faces, the following process is applied, to a given face or set of faces: (i) The best candidate predictor is selected independently for each displacement; or (ii) The candidate predictor that has been selected the most frequently is used to predict all predictors of the given face or set of faces, and its index is signalled.

In one or more examples, the competition-based displacement skip and the competition based displacement skip are used jointly, to give the opportunity to either skip or provide a residual, in each case with different candidate predictors. The selection of one or the other method is signaled in the bitstream or inferred by information available at both encoder and decoder.

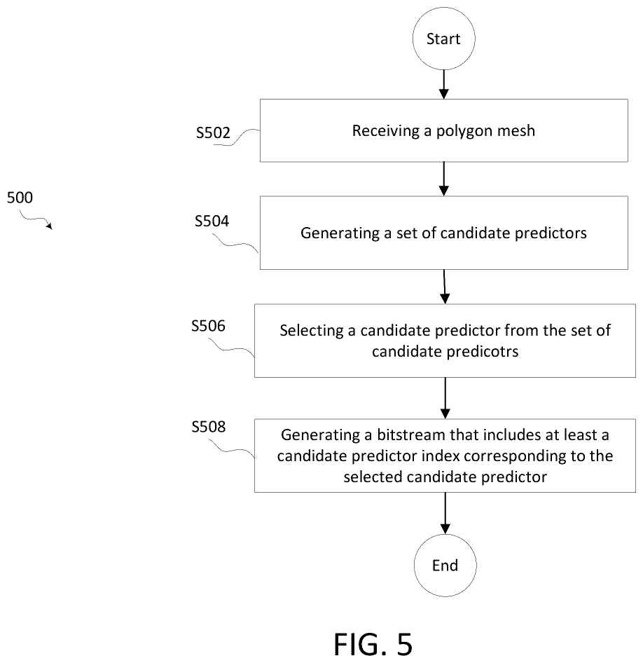

FIG. 5 illustrates an example encoding process 500, according to one or more embodiments. The encoding process 500 may be performed by encoder 203 (FIG. 2).

The process starts at operation S502 where a polygon mesh is received. The polygon mesh may correspond to one or more surfaces of objects in a picture.

The process proceeds to operation S504, where a set of candidate predictors is generated. The set of candidate predictors may be generated using any one of the methods described above.

The process proceeds to operation S506 where a candidate predictor is selected from the set of candidate predictors. The selected candidate predictor may be a candidate predictor that minimizes a cost function.

The process proceeds to operation S508, where a bitstream that includes a candidate predictor index corresponding to the selected candidate predictor.

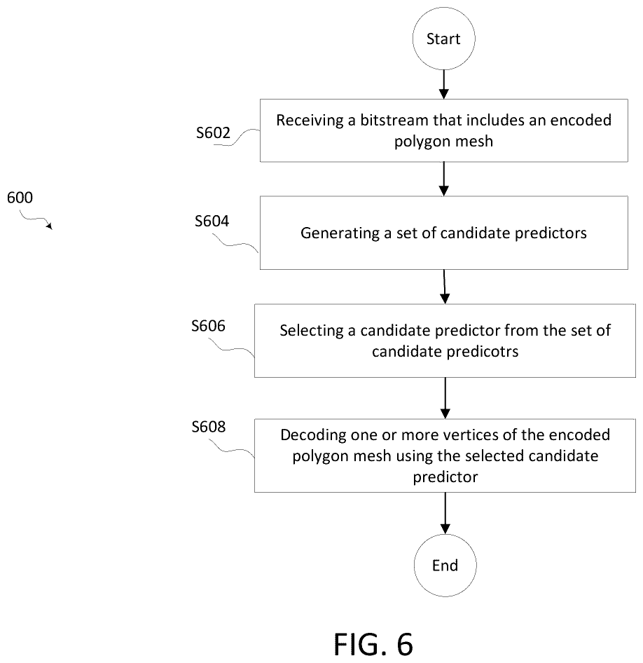

FIG. 6 illustrates an example decoding process 600, according to one or more embodiments. The process 600 may be performed by the decoder 210 (FIG. 2).

The process starts at operation S602, where a bitstream that includes an encoded polygon mesh is received.

The process starts at operation S604, where a set of candidate predictors is generated. The set of candidate predictors may be generated by the decoder 210 in accordance with any one of the methods described above.

The process starts at operation S606 where a candidate predictor from the set of candidate predictors is selected. The selected candidate predictor may be a candidate predictor that minimizes a cost function.

The process start at operation S608 where one of more vertices of the encoded polygon mesh are decoded using the selected candidate predictor.

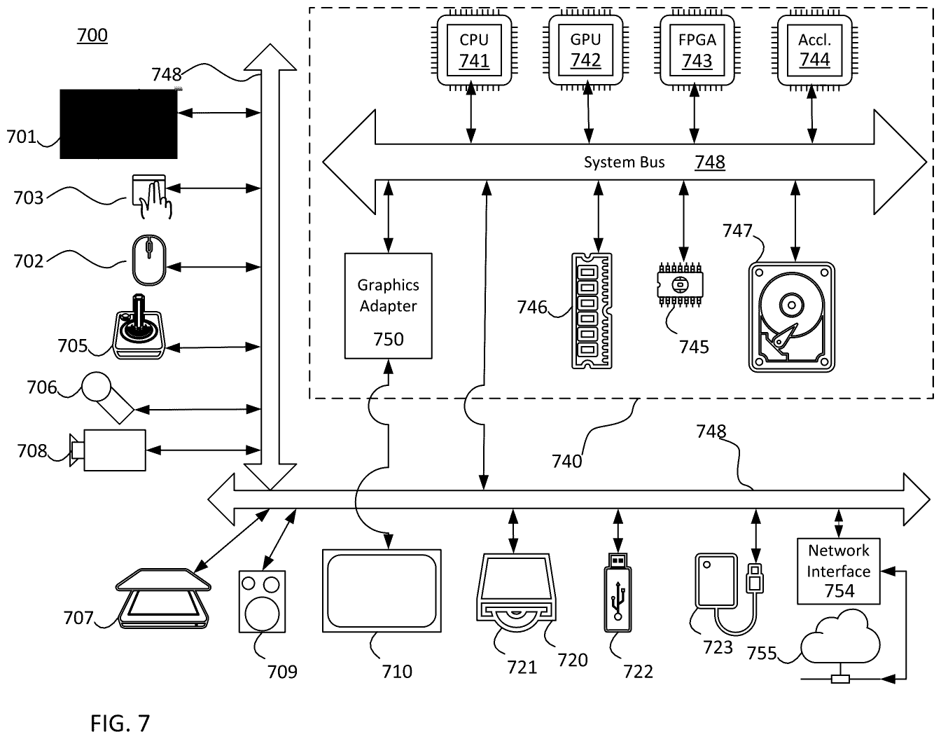

The techniques, described above, may be implemented as computer software using computer-readable instructions and physically stored in one or more computer-readable media. For example, FIG. 7 shows a computer system 700 suitable for implementing certain embodiments of the disclosure.

The computer software may be coded using any suitable machine code or computer language, that may be subject to assembly, compilation, linking, or like mechanisms to create code including instructions that may be executed directly, or through interpretation, micro-code execution, and the like, by computer central processing units (CPUs), Graphics Processing Units (GPUs), and the like.

The instructions may be executed on various types of computers or components thereof, including, for example, personal computers, tablet computers, servers, smartphones, gaming devices, internet of things devices, and the like.

The components shown in FIG. 7 for computer system 700 are examples and are not intended to suggest any limitation as to the scope of use or functionality of the computer software implementing embodiments of the present disclosure. Neither should the configuration of components be interpreted as having any dependency or requirement relating to any one or combination of components illustrated in the non-limiting embodiment of a computer system 700.

Computer system 700 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices may also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 701, mouse 702, trackpad 703, touch screen 710, data-glove, joystick 705, microphone 706, scanner 707, camera 708.

Computer system 700 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 710, data glove, or joystick 705, but there may also be tactile feedback devices that do not serve as input devices). For example, such devices may be audio output devices (such as: speakers 709, headphones (not depicted)), visual output devices (such as screens 710 to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system 700 may also include human accessible storage devices and their associated media such as optical media including CD/DVD ROM/RW 720 with CD/DVD or the like media 721, thumb-drive 722, removable hard drive or solid state drive 723, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 700 may also include interface to one or more communication networks. Networks may be wireless, wireline, optical. Networks may further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses 749 (such as, for example USB ports of the computer system 700; others are commonly integrated into the core of the computer system 700 by attachment to a system bus as described below (for example Ethernet interface into a PC computer system or cellular network interface into a smartphone computer system). Using any of these networks, computer system 700 may communicate with other entities. Such communication may be uni-directional, receive only (for example, broadcast TV), uni-directional send-only (for example CANbus to certain CANbus devices), or bi-directional, for example to other computer systems using local or wide area digital networks. Such communication may include communication to a cloud computing environment 755. Certain protocols and protocol stacks may be used on each of those networks and network interfaces as described above.

Aforementioned human interface devices, human-accessible storage devices, and network interfaces 754 may be attached to a core 740 of the computer system 700.

The core 740 may include one or more Central Processing Units (CPU) 741, Graphics Processing Units (GPU) 742, specialized programmable processing units in the form of Field Programmable Gate Areas (FPGA) 743, hardware accelerators for certain tasks 744, and so forth. These devices, along with Read-only memory (ROM) 745, Random-access memory 746, internal mass storage such as internal non-user accessible hard drives, SSDs, and the like 747, may be connected through a system bus 748. In some computer systems, the system bus 748 may be accessible in the form of one or more physical plugs to enable extensions by additional CPUs, GPU, and the like. The peripheral devices may be attached either directly to the core's system bus 748, or through a peripheral bus 749. Architectures for a peripheral bus include PCI, USB, and the like. A graphics adapter 750 may be included in the core 740.

CPUs 741, GPUs 742, FPGAs 743, and accelerators 744 may execute certain instructions that, in combination, may make up the aforementioned computer code. That computer code may be stored in ROM 745 or RAM 746. Transitional data may be also be stored in RAM 746, whereas permanent data may be stored for example, in the internal mass storage 747. Fast storage and retrieve to any of the memory devices may be enabled through the use of cache memory, that may be closely associated with one or more CPU 741, GPU 742, mass storage 747, ROM 745, RAM 746, and the like.

The computer readable media may have computer code thereon for performing various computer-implemented operations. The media and computer code may be those specially designed and constructed for the purposes of the present disclosure, or they may be of the kind well known and available to those having skill in the computer software arts.

As an example and not by way of limitation, the computer system having architecture 700, and specifically the core 740 may provide functionality as a result of processor(s) (including CPUs, GPUs, FPGA, accelerators, and the like) executing software embodied in one or more tangible, computer-readable media. Such computer-readable media may be media associated with user-accessible mass storage as introduced above, as well as certain storage of the core 740 that are of non-transitory nature, such as core-internal mass storage 747 or ROM 745. The software implementing various embodiments of the present disclosure may be stored in such devices and executed by core 740. A computer-readable medium may include one or more memory devices or chips, according to particular needs. The software may cause the core 740 and specifically the processors therein (including CPU, GPU, FPGA, and the like) to execute particular processes or particular parts of particular processes described herein, including defining data structures stored in RAM 746 and modifying such data structures according to the processes defined by the software. In addition or as an alternative, the computer system may provide functionality as a result of logic hardwired or otherwise embodied in a circuit (for example: accelerator 744), which may operate in place of or together with software to execute particular processes or particular parts of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

While this disclosure has described several non-limiting embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method of encoding performed by at least one processor, the method comprising:
receiving a polygon mesh that includes a plurality of vertices;
generating a set of candidate predictors, each candidate predictor in the set of candidate predictors corresponding to a respective displacement vector between a vertex from the plurality of vertices to a vertex to be coded;
selecting a candidate predictor from the set of candidate predictors; and
generating a bitstream that includes at least a candidate predictor index corresponding to the selected candidate predictor.

2. The method according to claim 1, wherein at least one candidate predictor in the set of candidate predictors is computed using a weight sum of one or more displacement vectors of vertices neighboring the at least one candidate predictor.

3. The method according to claim 1, wherein a first candidate predictor in the set of candidate predictor is provided a higher priority than a second candidate predictor in the set of candidate predictors based on one or more characteristics of the polygon mesh.

4. The method according to claim 3, wherein the one or more characteristics include a curvature of the polygon mesh, a size of faces of the polygon mesh, or distance between vertices.

5. The method according to claim 1, wherein the candidate predictor selected from the set of candidate predictors is the candidate predictor that minimizes a cost function.

6. The method according to claim 5, wherein the cost function is in accordance with a distortion associated with a reconstructed displacement after prediction with a candidate predictor.

7. The method according to claim 5, wherein the cost function is in accordance with a rate associated with signaling information associated with the bitstream.

8. The method according to claim 1, further comprising:
determining a residual displacement corresponding to a difference between a displacement to be predicted and the selected candidate predictor,
wherein the bitstream includes the residual displacement.

9. The method according to claim 1, wherein the selected candidate predictor is associated with a plurality of faces in the polygon mesh.

10. The method according to claim 9, wherein the plurality of faces are consecutive faces in an encoding order.

11. The method according to claim 9, wherein the plurality of faces are weight in accordance with a size of a face, wherein larger faces have a higher weight.

12. A method of decoding performed by at least one processor, the method comprising:
receiving a bitstream that includes an encoded polygon mesh;
generating a set of candidate predictors associated with the encoded polygon mesh;
selecting a candidate predictor from the set of candidate predictors; and
decoding one or more vertices of the encoded polygon mesh using the selected candidate predictor.

13. The method according to claim 12, further comprising:
parsing the bitstream to extract an index corresponding to the selected candidate predictor.

14. The method according to claim 12, wherein an index corresponding to the selected candidate predictor is inferred based on one or more characteristics of the polygon mesh.

15. The method according to claim 12, further comprising:
parsing the bitstream to extract a residual displacement;
determining a reconstructed displacement using the extracted residual displacement and the selected candidate predictor.

16. The method according to claim 12, wherein at least one candidate predictor in the set of candidate predictors is computed using a weight sum of one or more displacement vectors of vertices neighboring the at least one candidate predictor.

17. The method according to claim 12, wherein a first candidate predictor in the set of candidate predictor is provided a higher priority than a second candidate predictor in the set of candidate predictors based on one or more characteristics of the polygon mesh.

18. The method according to claim 3, wherein the one or more characteristics include a curvature of the polygon mesh, a size of faces of the polygon mesh, or distance between vertices.

19. The method according to claim 12, wherein the candidate predictor selected from the set of candidate predictors is the candidate predictor that minimizes a cost function.

20. A method of encoding performed by at least one processor, the method comprising:
generating a bitstream for a polygon mesh that includes a plurality of vertices,
wherein a set of candidate predictors are generated, each candidate predictor in the set of candidate predictors corresponding to a respective displacement vector between a vertex from the plurality of vertices to a vertex to be coded,
wherein a candidate predictor from the set of candidate predictors is selected,
wherein a candidate predictor index corresponding to the selected candidate predictor is included in the bitstream.
